(19) United States
(12) Patent Application Publication
(10) Pub. No.: US 2018/0312405 A1
(43) Pub. Date: Nov. 1, 2018

(54) EXTRACTION OF PLATELET-LIKE PARTICLES FROM AQUEOUS TO NON-AQUEOUS MEDIA

(71) Applicant: The Australian National University, Acton, Australian Capital Territory (AU)

(72) Inventor: Shannon Marc Notley, Pearce (AU)

(21) Appl. No.: 15/769,631

(22) PCT Filed: Oct. 14, 2016
(86) PCT No.: PCT/AU2016/000352

§ 371 Date: Apr. 19, 2018

(30) Foreign Application Priority Data
Oct. 15, 2015 (AU) 2015904217

(51) Int. Cl. C01B 32/194; C09K 5/10; C09K 8/36; C10M 173/00; C08K 3/04

(52) U.S. Cl. CPC C01B 32/194; C09K 5/10; B82Y 40/00; C10M 173/00; C08K 3/042; C09K 8/36

(57) ABSTRACT

The invention relates to a method for preparing a dispersion of platelet-like particles in a non-aqueous medium. The method comprises combining a dispersion of said particles in water with the non-aqueous medium to provide a mixture comprising the non-aqueous medium, water and the particles, and then removing the water from the mixture.

### FIELD

The invention relates to the transfer of platelet-like particles from an aqueous medium into a non-aqueous medium.

### Priority

This application claims priority from Australian Provisional Patent Application No. 2015904217, the entire contents of which are incorporated herein by cross-reference.

### Background

There is considerable commercial interest in nano-particles and dispersions thereof. Graphene in particular has shown promise due to its interesting electronic, thermal and mechanical properties. Graphene comprises sheets of an extended carbocyclic aromatic network and may be regarded as an exfoliated graphite. The use of graphene in commercial applications has however been limited due to the relatively small amounts that are produced using conventional techniques. Also, graphene sheets have a strong tendency to aggregate even in dispersion. This problem increases with increasing concentration of the graphene in the dispersion. Similar problems pertain to other materials which consist of platelets or sheets, such as talc, clays etc.

Aggregation of platelets or sheets (referred to herein as “two dimensional particles” or (2D particles”) in dispersion may be inhibited by use of surfactants. However many surfactants can desorb from the surface of exfoliated sheets, leading to aggregation and possibly instability of the dispersion. Furthermore, if the exfoliated sheets are dried, redispersion is generally difficult due to reaggregation. Resuspended materials may require sonication in order to re-exfoliate the material. These problems have been addressed in International Patent Application PCT/AU2012/000847 (publication no. WO2013/010211): “Exfoliating laminar material by ultrasonication in surfactant”, the entire contents of which are incorporated by cross-reference.

A problem with the invention of WO2013/010211 was that it primarily dealt with aqueous dispersions of exfoliated materials. However in many applications, these materials are required in other solvents. There has in the past been some effort to produce dispersions of such two dimensional particles, e.g. graphene, directly in solvents in which they are to be used. However commonly if the solvent in which the two dimensional particles are dispersed is not predominantly water, concentrations of directly exfoliated materials can be very low. If the two dimensional particles are generated in a medium which is predominantly water, the yield of the exfoliated particles can be significantly higher. Even when exfoliation can be achieved in media other than water, there is generally a limited range of such media for each type of 2D particles.

There is therefore a need to generate dispersions of exfoliated or platelet-like materials in media other than water.

### SUMMARY OF INVENTION

In a first aspect of the invention there is provided a method for preparing a dispersion of platelet-like particles in a non-aqueous medium, said method comprising: a) combining a dispersion of said particles in water with the non-aqueous medium to provide a mixture comprising the non-aqueous medium, water and the particles, and b) removing the water from the mixture.

The following options may be used in conjunction with the first aspect, either individually or in any suitable combination.

The platelet-like particles may comprise, or may be, exfoliated graphite, exfoliated talc, exfoliated molybdite, exfoliated tungstite, exfoliated tungsten disulfide, exfoliated molybdenum disulfide, exfoliated bismuth telluride, exfoliated mica or exfoliated clay, or a mixture of any two thereof. They may comprise, or may be, graphene.

The platelet-like particles may have a complete monolayer of a surfactant on the surface thereof. The surfactant may be a polymeric surfactant. It may be non-ionic. The dispersion of the particles in water may comprise a salt capable of complexing or otherwise interacting with said the surfactant. The salt may be a salt of a multivalent cation. It may be a ferric salt, e.g. ferric chloride. The method may comprise adding said salt to the water prior to step a).

The method may comprise the step of exfoliating a laminar material in water so as to prepare the dispersion of platelet-like particles in water. The step of exfoliating may comprise ultrasonicating the laminar material in an aqueous solution of a surfactant for sufficient time to form the platelet-like particles in the solution. The ultrasonication may be such that, at all times during the ultrasonication, the concentration of the surfactant in the solution is maintained sufficient to form a complete monolayer on the surfaces of the laminar material and the platelet-like particles in the solution.

The non-aqueous medium may have a lower vapour pressure than water. In this event, step b) may comprise evaporating the water from the mixture so as to leave the dispersion of platelet-like particles in the non-aqueous medium. Suitable non-aqueous media include benzyl alcohol, glycol ethers, oligoethers (these may be hydroxyl terminated, monoalkoxylated or dialkoxylated, e.g. diethylene glycol and its mono- and dimethoxylated derivatives), reactive amines and dipolar aprotic solvents as well as mixtures of any two or more thereof. The non-aqueous medium may be miscible with water. Step a) may also involve agitating the dispersion with the non-aqueous medium. The non-aqueous medium may be a liquid at 25° C.

The non-aqueous medium may be immiscible with water. In this event step a) may comprise agitating the dispersion with the non-aqueous medium, and step b) may comprise allowing the mixture to separate and separating the water from the dispersion of the platelet-like particles in the non-aqueous medium. Suitable non-aqueous media include halogenated media and mixtures thereof. If the non-aqueous medium is immiscible with water, it may be a liquid at some temperature between about 0 and about 100° C., commonly at some temperature between about 20 and about 50° C.

The method may additionally comprise adding an azeotroping liquid to the dispersion of the platelet-like particles in the non-aqueous medium, said azeotroping liquid forming an azeotrope with water and said azeotrope having a higher vapor pressure than the non-aqueous medium, and then evaporating the azeotrope from the the dispersion (e.g. boiling the azeotrope off from the dispersion).

The method may additionally comprise exposing the dispersion of the platelet-like particles in the non-aqueous medium to a solid drying agent, and separating the solid drying agent from said dispersion. Commonly this will be done at a temperature at which the non-aqueous medium is a liquid. The solid drying agent may be for example a zeolite. It may have sufficiently large particle size as to be removable without removing substantial amounts of the platelet-like particles. It may be separable by sedimentation or by flotation in the dispersion of the platelet-like particles in the non-aqueous medium.

In one embodiment there is provided a method for preparing a dispersion of platelet-like particles in a non-aqueous medium, optionally a water miscible non-aqueous medium, which has a lower vapour pressure than water, said method comprising: a) combining a dispersion of said particles in water with the non-aqueous medium to provide a mixture comprising the non-aqueous medium, water and the particles, and b) removing the water from the mixture by evaporating the water from the mixture so as to leave the dispersion of platelet-like particles in the non-aqueous medium. The platelet-like particles may comprise, or may be, graphene.

In another embodiment there is provided a method for preparing a dispersion of graphene particles in a non-aqueous medium comprising at least two amine groups per molecule, said non-aqueous medium having a lower vapour pressure than water, said method comprising: a) combining (optionally agitating) a dispersion of said particles in water with the non-aqueous medium to provide a mixture comprising the non-aqueous medium, water and the particles, and b) removing the water from the mixture by evaporating the water from the mixture so as to leave the dispersion of graphene particles in the non-aqueous medium. In this embodiment, the non-aquous medium may be a liquid at the temperature at which step a) is conducted, said temperature being between about 0 and about 100° C.

In another embodiment there is provided a method for preparing a dispersion of platelet-like particles in a non-aqueous medium, e.g. a halogenated medium, which is immiscible with water, said method comprising: a) agitating a dispersion of said particles in water with the non-aqueous medium to provide a mixture comprising the non-aqueous medium, water and the particles, and b) allowing the mixture to separate and separating the water from the resulting dispersion of the platelet-like particles in the non-aqueous medium. In this embodiment, the non-aquous medium may be a liquid at the temperature at which step a) is conducted, said temperature being between about 0 and about 100° C.

In another embodiment there is provided a method for preparing a dispersion of platelet-like particles in a non-aqueous medium, said method comprising: a) adding a salt of a multivalent ion, e.g. ferric chloride, to water and combining a dispersion of said particles in said water with the non-aqueous medium to provide a mixture comprising the non-aqueous medium, water and the particles, and b) removing the water from the mixture.

In a second aspect of the invention there is provided a dispersion of platelet-like particles in a non-aqueous medium, said dispersion being produced by the method of the first aspect.

In a third aspect of the invention there is provided use of a dispersion according to the second aspect for the manufacture of a polymer composite.

In a fourth aspect of the invention there is provided a method for preparing a polymer composite, said method comprising preparing a dispersion of platelet-like particles in a non-aqueous medium by the method of the first aspect, said non-aqueous medium comprising at least two amine groups per molecule, combining said dispersion with a reagent comprising at least two amine-reactive groups per molecule, and allowing said non-aqueous medium to react with the reagent so as to form a polymer composite comprising the platelet-like particles dispersed in a reaction product of the non-aqueous medium and the reagent.

In an embodiment there is provided a method for preparing a polymer composite, said method comprising:
preparing a dispersion of graphene particles in a non-aqueous medium comprising at least two amine groups per molecule, said non-aqueous medium being miscible with water and having a lower vapour pressure than water, said method comprising:
   a) combining a dispersion of said particles in water with the non-aqueous medium to provide a mixture comprising the non-aqueous medium, water and the particles, and
   b) removing the water from the mixture by evaporating the water from the mixture so as to leave the dispersion of platelet-like particles in the non-aqueous medium; and
combining said dispersion with a reagent comprising at least two amine-reactive groups per molecule, and
allowing said non-aqueous medium to react with the reagent so as to form a polymer composite comprising the platelet-like particles dispersed in a reaction product of the non-aqueous medium and the reagent.

In this embodiment the step of preparing the dispersion may comprise additional step c) after step b), of exposing the dispersion of the platelet-like particles in the non-aqueous medium to a solid drying agent, and separating the solid drying agent from said dispersion.

In a fifth aspect of the invention there is provided use of a dispersion according to the second aspect in semi-conductor manufacture, as a lubricant, as a catalyst, or in the production of a coating composition, ink, thermal interface material, paint, synthetic fibre or film (e.g. lyocell, aramid).

In a sixth aspect of the invention there is provided a process for preparing a dispersion of graphene, said method comprising combining a dispersion of said graphene in water with a water miscible organic liquid to provide said dispersion comprising the organic liquid, water and graphene.

The following options may be used in conjunction with the sixth aspect, either individually or in any suitable combination.

The organic liquid may be a dipolar aprotic liquid. It may be any one of ethylene glycol, propylene glycol, liquid borate esters, polyethylene oxide, 1-methyl-2-pyrrolidinone, dimethyl sulfoxide, hexamethylphosphoramine, hexamethylphosphoramide or an ionic liquid or may be a mixture of any two or more of these. It may have a thermal conductivity of at least about 0.1 W/m.K at 25° C.

The ratio of water to organic liquid may be between about 1:5 and 5:1, optionally 1:3 and 3:1 or 1:2 and 2:1. It may be for example about 1:5, 1:4, 1:3, 1:2, 1:1, 2:1, 3:1, 4:1 or 5:1.

The process may additionally comprise the step of removing at least a portion, optionally essentially all, of the water. Alternatively the water may remain in the dispersion.

In a seventh aspect of the invention there is provided a heat transfer fluid comprising a dispersion of graphene in a water miscible organic liquid and optionally water. In some embodiments the heat transfer fluid comprises less than about 1% by volume water. In other embodiments the heat transfer fluid comprises between about 10 and about 80% by volume water. The organic liquid may have a thermal conductivity of at least about 0.1 W/m.K at 25° C.

The heat transfer fluid of the seventh aspect may be made by the process of the sixth aspect. The process of the sixth aspect may be for making the heat transfer fluid of the seventh aspect.

### BRIEF DESCRIPTION OF DRAWINGS

FIG. 1 shows a graph of graphene concentration vs extraction number for repeated extraction into chloroform.

FIG. 2 shows a graph of thermal conductivity of graphene in ethylene glycol suspensions determined using the laser flash method (ASTM E1461-13).

FIG. 3 shows a graph of thermal conductivity of graphene in tetraethylene glycol suspensions determined using the laser flash method (ASTM E1461-13).

### DESCRIPTION OF EMBODIMENTS

The invention relates to a method for preparing a dispersion of platelet-like particles in a non-aqueous medium. In this method, a dispersion of said particles in water is combined with the non-aqueous medium to provide a mixture comprising the non-aqueous medium, water and the particles. Following this, the water is removed from the mixture. This method enables higher concentration of the platelet-like particles in the non-aqueous medium than has previously been attainable. The actual concentration that is achievable will depend on the nature of the particles and of the medium.

In this context, a dispersion may be considered to refer to solid particles dispersed through a medium. The solid particles may be dispersed substantially homogeneously. The dispersion may be a suspension. It may be a liquid dispersion or may be a solid dispersion. It may be stable. It may be sufficiently stable that, if it is agitated so as to achieve substantial homogeneity and then allowed to stand undisturbed at 25° C., it remains substantially homogeneous for 1 hour, or for 1 day, or for one week, or for 1 month. “Substantially homogeneous” should be taken to indicate that the content of the upper 50% by volume of the dispersion contains between 45% and 55%, optionally between 49% and 51% or between 49.5 and 50.5% by volume, of the solid particles. It will be understood that, in the event that the dispersion is a solid dispersion, it is likely to be nearly indefinitely stable, since the presence of a solid matrix of the non-aqueous medium would prevent, or at least strongly inhibit, separation of the dispersed particles.

In the context of this application, platelet-like particles are particles in which their thickness is small relative to their width and length. Commonly the thickness will be less than about 10% of the smaller of width and length, or less than about 5, 2 or 1%. Width and length may be comparable. They may be approximately equal, or may be in a ratio between about 5:1 and about 1:5, or about 2:1 to about 1:2. Commonly such particles are obtained by exfoliation of laminar materials such as graphite, talc, molybdite, tungstite, tungsten disulfide, molybdenum disulfide, bismuth telluride, mica or clay. The exfoliation may be complete or may be partial. Thus the platelet-like particles may comprise single layers (i.e. be atomic thickness) or may comprise a small number (e.g. 2, 3, 4, 5, 6, 7, 8, 9 or 10) layers. There may be particles with different numbers of layers within the dispersion. One particular example of platelet-like particles is graphene, which may be obtained by exfoliation of graphite. It will therefore be understood that the laminar material from which the platelet-like material is obtained may have a structure comprising multiple, approximately parallel, layers of the particles of the platelet-like particles.

The term “non-aqueous medium” refers to a substance that is capable of having the platelet-like particles dispersed therein. It may be liquid at some temperature between about 15 and about 50° C., e.g. at about 15, 20, 25, 30, 35, 40, 45 or 50° C. In some instances, however, the non-aqueous medium may have a higher melting point, e.g. over about 50° C., or over about 60, 80, 100, 120, 140, 160, 180 or 200° C. At least in the event that the non-aqueous medium has a melting point above 100° C., it is preferred that it be water miscible and that separation of water from the mixture of water, non-aqueous medium and particles be achieved by evaporation of water therefrom. The term “non-aqueous” indicates that the medium is not water. It may comprise small amounts of water, e.g. less than about 10% by weight, or less than about 5, 2 or 1% by weight, or it may be entirely free of water.

The non-aqueous medium may be miscible with water or may be immiscible with water. It will be understood that it is vary rare for any substance to be entirely immiscible with water: even very hydrophobic substances may contain a measurable amount of water at equilibrium. However in the present context the terms “miscible” and “immiscible” should be taken to refer to miscibility in the ratio in which the two media (water and the non-aqueous medium) are used in the invention. Thus step a) of the method involves combining a dispersion of said particles in water with the non-aqueous medium to provide a mixture. In this context therefore, “miscible” indicates that water and the non-aqueous medium are completely miscible (i.e. form a single phase) in the proportions in which they are used in step a), and “immiscible” indicates that they are not completely miscible in the proportions in which they are used in step a), even though they may in some instances be partially miscible in these proportions. This ratio (water/non-aqueous medium) may for example be (on a volume basis) from about 0.1 to about 10, or about 0.1 to 5,0.1 to 2,0.1 to 1,0.1 to 0.5, 0.1 to 0.2, 0.2 to 10, 0.5 to 10, 1 to 10, 2 to 10, 5 to 10, 0.2 to 5, 0.5 to 2, 0.2 to 1, 0.5 to 1, 1 to 10 or 1 to 5, e.g. about 0.1, 0.2, 0.3, 0.4, 0.5 0.6, 0.7, 0.8, 0.9, 1, 1.5, 2, 2.5, 3, 3.5, 4, 4.5, 5, 6, 7, 8, 9 or 10. In the present specification, the term “miscible” should be taken to include “soluble” and similarly “immiscible” to include“insoluble” in the event that the non-aqueous medium is a solid at the temperature where the miscibility is assessed.

A higher ratio of aqueous dispersion (i.e. the dispersion of the platelet-like particles in water) to non-aqueous medium may be used in order to concentrate the particles in the non-aqueous medium. Thus for example if a ratio of aqueous dispersion to non-aqueous medium of 2:1 is used, then (provided essentially all particles are transferred), the resulting dispersion in the non-aqueous medium would be approximately twice the concentration of particles than the starting aqueous dispersion.

Step a) of the invention may be conducted at any suitable temperature, depending on the specifics of the case. For example, lower temperatures may be used in order to improve stability, reduce aggregation etc. whereas higher temperatures may be used in order to reduce viscosity and/or to ensure that the non-aqueous medium is in its liquid state. The effect on miscibility of water and the non-aqueous medium should also be considered when determining the optimum temperature. Suitable temperatures are commonly from about 0 to about 50° C., or 0 to 30, 0 to 20, 0 to 10, 10 to 50, 20 to 50, 10 to 30 or 20 to 40° C., e.g. about 0, 5, 10, 15, 20, 25, 30, 35, 40, 45 or 50° C., however higher temperatures may at times be used. The temperature should be at or above the melting point of the non-aqueous medium.

Suitable water miscible non-aqueous media include reactive compounds that may be used in the manufacture of polymeric materials. These include diamino and polyamino compounds and prepolymers such as those which may be used in the manufacture of polyurethanes, polyamides, epoxy polymers etc. Suitable such compounds include tetramethylenediamine and hexamethylenediamine. Other suitable water miscible non-aquous media include high boiling polar aprotic solvents such as ionic media, hexamethylphosphorus triamine and hexamethyl phosphoramide (HMPT and HMPA), dimethyl sulfoxide, dimethyl acetamide, dimethyl formamide, N-methylpyrrolidone (NMP), N-methylmorpholine-N-oxide etc, as well as high boiling alcohols such as benzyl alcohol, glycol ethers such as diethylene glycol, diethylene glycol monoethyl ether etc.

Suitable water immiscible non-aqueous media include hydrocarbons, commonly aromatic hydrocarbons, having boiling points above about 110° C., or about 120, 125, 130, 135, 140, 145 or 150° C. Others include halogenated hydrocarbons, e.g. chlorinated or brominated hydrocarbons. These may be monohalogenated or dihalogenated or may have more than 2 (e.g. 3, 4, 5 or 6) halogen atoms per molecule. In the event that the halogenated hydrocarbon has more than one halogen atom per molecule, all of the halogen atoms may be the same, or one or more may be different. The halogenated hydrocarbons may be aromatic or may be aliphatic. Examples include dibromodichloromethane, bromochlorobenzene, tetrachloromethane, chloroform, dichloromethane, chlorobenzene, dichlorobenzene, dichloroethane, benzyl chloride, chlorotoluene etc.

Where mention is made herein of “water” it should be understood that the water may not be pure. It may comprise dissolved materials. These may be salts, or they may be dissolved gases or they may be surfactants or they may be some other type of solute. There may be more than one type of dissolved material in the water. In some embodiments the water of the dispersion of step a) of the method does not have any organic solvent dissolved therein.

The dispersion of the particles in water may have a content of platelet-like particles of at least about 0.01%, or of at least about 0.02, 0.05, 0.1 0.2, 0.5, 1, 2, 5 or 10%, or from about 0.01 to about 20%, or about 0.01 to 10, 0.01 to 1, 0.05 to 20, 0.05 to 10, 0.05 to 1, 0.1 to 20, 0.1 to 10, 0.1 to 5, 0.1 to 1, 0.1 to 1, 0.1 to 0.5, 0.5 to 20, 1 to 20, 2 to 20, 5 to 20, 10 to 20, 0.5 to 5, 1 to 10, 1 to 5 or 5 to 10%, e.g. about 0.01, 0.02, 0.03, 0.04, 0.05, 0.06, 0.07, 0.08, 0.09, 0.1, 0.2, 0.3, 0.4, 0.5, 1, 2, 3, 4, 5, 6, 7, 8, 9, 10, 11, 12, 13, 14, 15, 16, 17, 18, 19 or 20%. The resulting dispersion of the particles in the non-aqueous medium may be at least about about 0.01%, or of at least about 0.02, 0.05, 0.1 0.2, 0.5, 1, 2, 5 or 10%, or from about 0.01 to about 20%, or about 0.01 to 10, 0.01 to 1, 0.0.5 to 20, 0.05 to 10, 0.05 to 1, 0.1 to 20, 0.1 to 10, 0.1 to 5, 0.1 to 1, 0.1 to 1, 0.1 to 0.5, 0.5 to 20, 1 to 20, 2 to 20, 5 to 20, 10 to 20, 0.5 to 5, 1 to 10, 1 to 5 or 5 to 10%, e.g. about 0.01, 0.02, 0.03, 0.04, 0.05, 0.06, 0.07, 0.08, 0.09, 0.1, 0.2, 0.3, 0.4, 0.5, 1, 2, 3, 4, 5, 6, 7, 8, 9, 10, 11, 12, 13, 14, 15, 16, 17, 18 19 or 20%. These concentrations may be on a w/w or w/v basis.

Commonly the dispersion of particles in water is stabilised by the presence of a surfactant. The surfactant is preferably present as a complete monolayer on the surface of the particles. The monolayer of surfactant may persist on the surfactant of the particles through the method so that the particles in the non-aqueous medium also have a monolayer of the surfactant on the surface thereof

The surfactant may be polymeric. The surfactant may be a non-ionic surfactant. It may be a copolymer of ethylene oxide and propylene oxide. It may have a dy/dc (rate of change of surface tension with change in concentration) value in water of less than about 0 or may be from about −0.1 to about −5 Nm⁻¹ mol⁻¹ .L. The cmc (critical micelle concentration) of the surfactant may be greater than about 1 mM, or greater than about 1.5, 2, 2.5 or 3 mM, or may be about 1 to about 5 mM, or about 1 to 3, 1 to 4, 1.5 to 5, 2 to 5, 1.5 to 3 or 2 to 4 mM, e.g. about 0.5, 1, 1.5, 2, 2.5, 3, 3.5, 4, 4.5 or 5 mM.

If the surfactant is polymeric it may have a molecular weight (number average or weight average) of about 500 to about 50000, or about 500 to 10000, 500 to 5000, 500 to 1000, 1000 to 50000, 10000 to 50000, 1000 to 10000, 1000 to 5000 or 5000 to 10000, e.g. about 500, 600, 700, 800, 900, 1000, 1500, 2000, 2500, 3000, 3500, 4000, 4500, 5000, 6000, 7000, 8000, 9000, 10000, 15000, 20000, 25000, 30000, 35000, 40000, 45000 or 50000. It may have a narrow molecular weight range or a broad molecular weight range. The ratio Mw/Mn may be greater than about 1.1, or greater than about 1.2, 1.3, 1.4, 1.5, 2, 3, 4 or 5, or it may be less than about 5, or less than about 4, 3, 2, 1.5 or 1.2. It may for example be about 1.1, 1.2, 1.3, 1.4, 1.5, 2, 2.5, 3, 3.5, 4, 4.5 or 5. It may have a degree of polymerisation of about 10 to about 1000, or about 10 to 500, 10 to 200, 10 to 100, 10 to 50, 20 to 1000, 50 to 1000, 100 to 1000, 500 to 1000, 20 to 200, 20 to 100 or 100 to 200, e.g. about 10, 15, 20, 25, 30, 35, 40, 45, 50, 60, 70, 80, 90, 100, 150, 200, 250, 300, 350, 400, 450, 500, 600, 700, 800, 900 or 1000. Mixtures of surfactants may be used. In this case, at least one of the surfactants, optionally all, of the surfactants may be as described above.

The surfactant may be a copolymer. It may be an ethylene oxide-propylene oxide copolymer. It may have other comonomers or may have no other comonomers. It may be an amine having one or more (optionally 3) ethylene oxide-propylene oxide copolymer substituents on the nitrogen atom. It may be a block copolymer. It may be a triblock copolymer. It may be an ethylene oxide-propylene oxide block copolymer. It may be a poloxamer. It may be an ethylene oxide-propylene oxide-ethylene oxide triblock copolymer. The two ethylene oxide blocks may be the same length or may be different lengths. The proportion of ethylene oxide in the polymer may be about 10 to about 90% by weight or mole, or about 10 to 50, 10 to 30, 50 to 90, 70 to 90, 20 to 80, 20 to 50, 50 to 80, 20 to 40 or 60 to 80%, e.g. about 10, 20, 30, 40, 50, 60, 70, 80 or 90%.

The surfactant may have an HLB (hydrophilic/lipophilic balance) of greater than about 6, or greater than about 7, 8, 10, 12, 15 or 20, or of about 6, 7, 8, 9, 10, 11, 12, 13, 14, 15, 16, 17, 18, 19, 20, 21, 22, 23, 24 or greater than 24. Suitable surfactants which may be used in the present invention include Pluronic® P123 (nominally HO(CH₂CH₂O)₂₀(CH₂CH(CH₃)O)₇₀(CH₂CH₂O)₂₀H: HLB about 7), Pluronic® L31 (nominally HO(CH₂CH₂O)₂(CH₂CH(CH₃)O)₁₆(CH₂CH₂O)₂H: HLB about 1-7), Pluronic® F127 (nominally HO(CH₂CH₂O)₁₀₁(CH₂CH(CH₃)O)₅₆(CH₂CH₂O)₁₀₁H: HLB about 22) and Pluronic® F108 (nominallyHO(C₂H₄O)₁₄₁(C₃H₆O)₄₄(C₂H₄O)₁₄₁H: HLB>24) and aminofunctional polyethers (for example those sold under the trade name Jeffamine®). In general, surfactants having higher HLB also have higher cloud point. Commonly surfactants with HLB over about 12 have a cloud point over about 100° C. In preferred embodiments therefore, the HLB of the surfactant may be over 12. The surfactant may have a cloud point over 100° C., or over about 110, 120, 130, 140 or 150° C. In general, a higher HLB is preferable so as to better stabilise the dispersion. The surfactant may be a non-foaming surfactant.

In some instances a salt may be present in the water. This may facilitate extraction into the non-aqueous medium. It may do so by increasing the hydrophobicity of the surfactant by complexing therewith or otherwise binding thereto. The salt may be added, either before or after combining the aqueous dispersion with the non-aqueous medium. The salt should be one that is capable of complexing with or otherwise binding to the halogenated compound. Commonly the salt is one having a multivalent (i.e. not monovalent, for example 2+, 3+ or 4+) cation. Suitable salts therefore include iron salts such as Fe³⁺, e.g. ferric chloride or ferric bromide, and La³⁺ salts. Other complexing salts such as Fe(SCN)²⁺, which can interact with the PEO chains of certain surfactants, may also be used. These are convenient as it is possible to determine their concentration colorimetrically in the non-aqueous phase. Suitable concentrations in the water are from about 0.01 to 0.5M, or about 0.05 to 0.5, 0.1 to 0.5, 0.1 to 0.5 or 0.05 to 0.2M, e.g. about 0.01, 0.02, 0.03, 0.04, 0.05, 0.06, 0.07, 0.08, 0.09, 0.1, 0.15, 0.2, 0.25, 0.3, 0.35, 0.4, 0.45 or 0.5M.

The removal of the water may be partial removal or may be total removal. In some instances, as will be described below in greater detail, the majority of the water is removed in an initial step and a subsequent drying step removes most or all of the residual water. The initial water removal step may for example remove at least about 90% of the water, or at least about 95, 96, 97, 98, 99 or 99.5% thereof. The degree of removal at this stage will depend on the nature of the non-aqueous medium and on the method of its removal.

The step of removing the water may be conducted by physical separation of two immiscible media or it may be conducted by evaporation of the water (e.g. using a rotary evaporator, or by distillation, optionally fractional distillation, or by freeze drying) or may be conducted by some other suitable method. The precise method of removing the water may depend on the nature of the non-aqueous medium.

In particular, if the non-aqueous medium is water miscible, the mixture formed in step a) of the method will have only a single medium phase (although it will also contain the dispersed particles as a solid phase). In this case a suitable method for removal of the water is by evaporation. Most commonly this will involve heating the mixture to the point where water evaporates or boils. In general, this will also require that the non-aqueous medium has a vapour pressure of the medium is lower than that of water. The non-aqueous medium may have a vapour pressure at 100° C. of less than about 90 kPa, or less than about 80, 70, 60, 50, 40, 30, 20 or 10 kPa, or may have a vapour pressure at 100° C. of about 90 kPa, or about 80, 70, 60, 50, 40, 30, 20 or 10 kPa. It may have a boiling point (at normal atmospheric pressure) of at least about 110, or at least about 120, 130, 140 or 150° C. In some instances it may have no measurable boiling point (i.e. it may decompose before a boiling point is reached).

The process described above may be considered to represent a fractional distillation of the mixture in order to remove the water but retain the majority (commonly at least about 60%, or at least about 70, 80 or 90%) of the non-aqueous medium. As noted above, in this instance, it is preferred that if a surfactant is present it should have a cloud point above 100° C., or above the temperature at which the water removal is conducted. The removal of the water may be facilitated by conducting step b) at reduced pressure, e.g. at below about 50 kPa absolute, or below about 40, 30, 20, 10, 5, 2 or 1 kPa, or between about 0.1 and about 50 kPa, or between about 0.1 and 20, 0.1 and 10, 0.1 and 5, 0.1 and 1, 1 and 50, 5 and 50, 10 and 50, 20 and 50, 10 and 20 or 1 and 10 kPa, e.g. at about 0.1, 0.2, 0.3, 0.4, 0.5, 0.6, 0.7, 0.8, 0.9, 1, 2, 3, 4, 5, 10, 15, 20, 25, 30, 35, 40, 45 or 50 kPa. The use of sub-atmospheric pressure enables the water removal to be conducted at a lower temperature than would be the case at atmospheric temperature. The removal may be additionally or alternatively facilitated by passing a gas through the mixture, commonly in the form of finely divided bubbles (e.g. by means of a fit or similar device) or by forming a thin film of the mixture (e.g. using a rotary evaporator). It is known that certain organic media can azeotrope with water, and this phenomenon may be used to reduce the temperature at which the water removal is conducted. For example, toluene can form an azeotrope with water which boils at around 84° C. Therefore addition of a suitable amount of toluene can allow the water to be removed by heating to about 84° C. (at 1 atmosphere pressure) whereas in the absence of toluene the boiling point of water is 100° C. (at 1 atmosphere). The water/toluene azeotrope contains about 80% toluene by weight, so in this example, it would be necessary to add toluene at up to about 4 times the weight of water.

Another suitable method for removal of water is by freeze drying. This may be conducted at any suitable temperature below or at the freezing point of the mixture of step a). This will depend on the nature of the non-aqueous medium, but is commonly below about 0° C. It may be conducted at a pressure of less than about 10 kPa absolute, or less than about 5, 2, 1, 0.5, 0.2 or 0.1 kPa. This requires that the vapour pressure of the non-aqueous medium is less than that of the water at the temperature at which the freeze drying is conducted.

If the non-aqueous medium is not water miscible, the water may also be removed by evaporation/boiling or freeze drying as described above, provided that the vapour pressure of the non-aqueous medium is higher than that of water. It should be noted that, as mentioned above, certain media azeotrope with water. Therefore if the non-aqueous medium itself forms an azeotrope with water, removal of water may be achieved in the event that the non-aqueous medium is itself more volatile than water (whether or not it is water miscible). For example carbon tetrachloride, which is not water miscible and is more volatile than water, has an azeotrope with water that boils at about 67° C., approximately 10° C. below the boiling point of pure carbon tetrachloride. Therefore water may be removed from this quite volatile solvent by evaporation of the azeotrope. Similarly, n-propanol, which is water miscible and is more volatile than water, has an azeotrope with water that boils at about 88° C., approximately 9° C. below the boiling point of pure n-propanol. Therefore water may be removed from this quite volatile solvent by evaporation of the azeotrope.

An alternative way to remove water from a non-aqueous medium that is immiscible with water is to simply separate the two media physically. Thus for example chlorobenzene is an example of a non-aqueous medium which is immiscible with water. It has a density of about 10% higher than that of water. Therefore a mixture of chlorobenzene and water will tend to separate such that the water is the upper layer and the chlorobenzene is the lower layer. These may be separated by allowing the lower layer to drain off, or by decanting the top layer, or by some similar method. The separation of two immiscible media may be facilitated by centrifugation. In this event, the outer medium will be the more dense, and may be separated by allowing it to exit the centrifuge. In a particular example of this, if the non-aqueous medium has a melting point between about 5 and about 100° C., the dispersion of particles in water and the non-aqueous medium may be agitated above the melting point of the non-aqueous medium, and the temperature may then be reduced to below said melting point so as to cause the non-aqueous medium, now having the particles dispersed therethrough, to solidify. The water may then be removed by simply decanting, or by filtering, or by some other suitable method for solid-liquid separation. In this event, the platelet-like particles will partition between the aqueous and non-aqueous phases. This partitioning may depend on such factors as the nature of the non-aqueous phase, the salt concentration in the aqueous phase, the ratio between the volumes of these two phases, the nature of the platelet-like particles and the nature of the surfactant used to stabilise the aqueous dispersion of the platelet-like particles. Commonly the partitioning will favour the non-aqueous phase (i.e. there will be more of the platelet-like particles in the non-aqueous phase than in the aqueous phase). The ratio of platelet-like particles in the non-aqueous phase to those in the aqueous phase may be between about 1 (i.e. 1:1) and 1000 (i.e. 1000:1), or about 1 and 100, 1 and 10, 1 and 5, 1 and 2, 2 and 1000, 10 and 1000, 100 and 1000, 500 and 1000, 10 and 100, 10 and 50, 50 and 100 or 50 and 500, e.g. about 1, 1.5, 2, 2.5, 3, 3.5, 4, 4.5, 5, 6, 7, 8, 9, 10, 15, 20, 25, 30, 35, 40, 45, 50, 60, 70, 80, 90, 100, 150, 200, 250, 300, 350, 400, 450, 500, 600, 700, 800, 900 or 1000.

Suitable water immiscible non-aqueous media include halogenated compounds (such as halogenated solvents), e.g. chlorinated compounds.

Once the water has been removed from the mixture, the resulting dispersion of the platelet-like particles in the non-aqueous medium may be dried. This is because the initial removal of water may be incomplete, and may therefore leave residual water in the dispersion. For example, it is generally difficult to remove all traces of water from a water miscible medium simply by fractional distillation of the water. Suitable processes for drying include adding an azeotroping medium and azeotroping off the residual water, e.g. using a Dean-Stark separator or other suitable device. Alternatively or additionally, water may be removed by use of a drying agent, e.g. a zeolite, an anhydrous salt, a water-reactive substance (e.g. sodium metal) or other suitable drying agent. The skilled person will readily understand which of these methods is appropriate for a particular instance (for example, use of sodium metal would be inappropriate when the non-aqueous medium is a protic medium such as an alcohol).

As discussed above, the platelet-like particles may be obtained by exfoliation, in particular in water. This may comprise ultrasonicating a precursor laminar material (e.g. graphite, mica etc.) in water. This is preferably conducted in the presence of surfactant, in such a way that at all stages of the ultrasonication the concentration of surfactant is sufficient to form a complete monolayer on the various particles (laminar and exfoliated platelet-like particles) in the dispersion. This process is discussed in detail in WO2013/010211. In one option, the initial surfactant concentration in the mixture is sufficient that, once the laminar material is exfoliated, it is sufficient to form a monolayer on the exfoliated particles formed during the subsequent ultrasonication. In another option, the initial surfactant concentration in the mixture is sufficent to form a monolayer on the initial laminar particles and further surfactant is added, either continuously or batchwise, during the sonication in order to ensure that at all times during the ultrasonication the surfactant level is sufficent to form a complete monolayer on all particles in the dispersion. It should be noted that as exfoliation proceeds, the total surface area increases and therefore more surfactant is required in order to form a monolayer on all particles in the dispersion.

In the first option, described above, the initial surfactant concentration may be readily determined from the calculated surface area of the exfoliated platelet-like particles and the known area per molecule of the surfactant. The latter may be obtained from readily available literature sources or may be measured experimentally for example using Langmuir-Blodgett apparatus. In the second option, described above, a suitable method for determining the rate of addition of surfactant is as follows.

1. The surface tension of the liquid phase (water) is measured as a function of concentration of surfactant and the concentration region identified corresponding to the surface tension of between a lower value (C1) and an expected threshold value (C2e, commonly corresponding to surface tension above about 48-50 mJ/m²).

2. Surfactant is first added to a dispersion of laminar material to produce a liquid of about concentration C1.

3. Sonication of the dispersion is commenced and samples are removed at regular time intervals. The surface tension of the liquid phase is determined as a function of time from commencement of sonication.

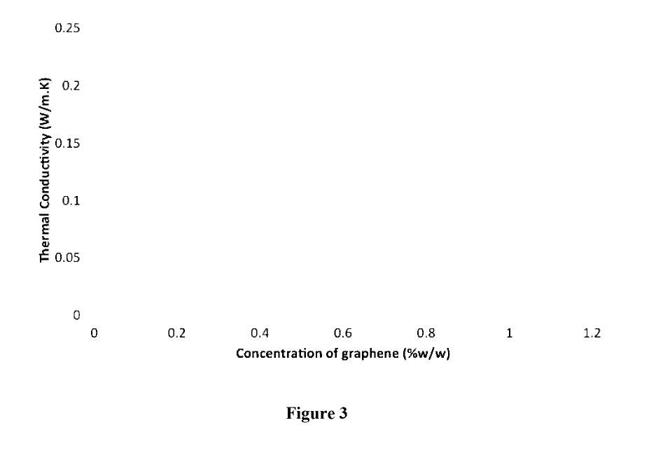

4. A calibration curve (see for example FIG. 3) is produced form the data obtained in step 3, which shows the surface tension of the solution as a result of surfactant consumed through adsorption to the exfoliated material as a function of time.

5. The time (T1) at which exfoliation ceases can be determined by observing plateauing of the surface tension/time curve from step 4. The concentration at that time is the threshold value C2.

6. Surfactant is replaced at the minimum rate of consumption. (C1−C2)/T1.

Commonly the lower value C1 is less than about 45 mJ/m², or less than about 44, 43, 42, 41 or 4045 mJ/m², or about 35 to about 45 mJ/m², or about 38 to 45, 40 to 45, 35 to 43, 35 to 40, 38 to 42 or 40 to 42 mJ/m², e.g. about 35, 36, 37, 38, 39, 40, 41, 42, 43, 44 or 45 mJ/m². The threshold value (C2e, C2) is commonly above 45 mJ/m², or above 46, 47, 48, 49 or 50, or between about 45 and 55, or about 45 to 50, 50 to 55, 48 to 52 to 47 to 40, e.g. about 45, 46, 47, 48, 49, 50, 51, 52, 53 ,54 or 55 mJ/m².

The ultrasonication may have a power of greater than about 10 W, or greater than about 20, 50, 100, 200, 500, 1000, 2000, 3000 or 4000 W, or may be about 10 to about 1000 W, or about 10 to 500, 10 to 200, 10 to 100, 10 to 50, 50 to 1000, 50 to 100, 100 to 1000, 200 to 1000, 500 to 1000, 1000 to 5000, 1000 to 4000, 200 to 5000, 100 to 500, 300 to 700 or 500 to 800 W, e.g. about 10, 20, 30, 40, 50, 60, 70, 80, 90, 100, 150, 200, 250, 300, 350, 400, 450, 500, 600, 700, 800, 900, 1000, 1500, 2000, 2500, 3000, 3500, 4000, 4500 or 5000 W. It may have a frequency of greater than about 2 kHz, or greater than about 5, 10, 20, 50, 100, 150 or 200 kHz, or about 2 to about 200 kHz, or about 2 to 100, 2 to 50, 2 to 20, 2 to 10, 10 to 200, 20 to 200, 50 to 200, 100 to 200, 10 to 100, 50 to 100 or 10 to 50 kHz, e.g. about 2, 3, 4, 5, 6, 7, 8, 9, 10, 15, 20, 25, 30, 35, 40, 45, 50, 60, 70, 80, 90, 100, 120, 140, 160, 180 or 200 kHz. A suitable ultrasonication condition may be for example about 50-100 W at about 10 to 50 kHz. The ultrasonication may be continued for sufficient time to achieve the desired degree of exfoliation. A suitable time may be for example at least about 0.5 minutes, or at least about 1, 2, 5, 10, 15, 20, 30, 40, 50 to 60 minutes, or about 0.5 to about 60 minutes, or about 0.5 to 30, 0.5 to 10, 0.5 to 2, 0.5 to 1, 1 to 60, 2 to 60, 5 to 60, 10 to 60, 30 to 60, 1 to 30, 1 to 10, 1 to 5, 5 to 30, 10 to 30, 10 to 20 or 5 to 15 minutes, e.g. about 0.5, 1, 2, 3, 4, 5, 10, 15, 20, 25, 30, 35, 40, 45, 50, 55 or 60 minutes. It may be less than about 30 minutes, or less than about 25, 20 or 15 minutes. In some instances ultrasonication itself may provide the agitation required to prepare a dispersion and no separate agitation may be required.

Dispersions of platelet-like particles in non-aqueous media prepared as described above may be used in a range of applications, including:
Lubricants: the platelet-like particles can provide lubricant properties
Semi-conductor manufacture: particularly if the platelet-like particles are graphene, they can have useful electronic properties which make dispersions of the particles particularly well suited for semi-conductor manufacture
Catalysis: due to the very high specific surface area of the platelet-like particles they can provide high catalytic activity. This may be as provided if the particles have intrinsic catalytic properties, or they may be modified by attachment of catalytic moieties in order to provide a high surface area catalytic dispersion.
Composite manufacture (including coatings): if the non-aqueous medium is reactive, i.e. is capable of reacting to form a polymer, then the dispersion of platelet-like particles can provide a facile route to a polymer filled with those particles. As the reinforcing and other beneficial properties of a filler are commonly dependent on their specific surface area, platelet-like particles such as those used in the present invention are very well suited to polymer property modification. Thus for example a reactive amine may be prepared with platelet-like particles as described herein, and then used to prepare a polyurethane. The polyurethane would then have the particles dispersed therein, providing a high level of reinforcement. Importantly, it is not only mechanical reinforcement that can be improved by inclusion of the platelet-like particles. Improved thermal conductivity is also important in many applications, for example in thermal interface materials in 3-D chip packaging in integrated circuit applications; in extending the working temperature of composite components in hot spots (e.g. aerospace and automotive), as inclusion of the platelet-like particles can lead to heat being more effectively dissipated over a larger volume; imparting improved thermal properties to synthetic fibres, in particular cellulose; improving heat dissipation in consumer electronics (e.g. mobile phones, wearables) etc. Improved electrical conductivity due to the presence of the platelet-like particles may also be important in for instance, lightning strike protection in composite aerospace components, electromagnetic radiation shielding for aerospace applications (in aircraft, satellites etc), consumer electronics and microelectronics, preparation of conducting inks (as a replacement for silver based inks which tarnish), formation of electrodes and supercapacitors for battery applications (usually from a solvent cast); improved compatibility with materials for 3-D printing (e.g. thermosets and thermoplastics).

Reactive amine groups may be amine groups capable of reacting with some other functional group in order to couple to another molecule. These may be primary amines or may be secondary amines. For example reactive amines may be used as non-aqueous media so as to produce a dispersion of graphene therein. This may then be used in manufacture of a polyurethane, epoxy resin, polyamide, polyimide or other suitable polymer system, filled with the graphene. Thus a specific example might involve making a polymer composite, by preparing a dispersion of platelet-like particles in a non-aqueous medium by the method described herein in which the non-aqueous medium comprising at least two amine groups per molecule, combining the resulting dispersion with a reagent comprising at least two amine-reactive groups (i.e. groups capable of reacting with the amine groups) per molecule, and allowing the non-aqueous medium to react with the reagent so as to form a polymer composite comprising the platelet-like particles dispersed in a reaction product of the non-aqueous medium and the reagent. Amine-reactive groups as described above may be for example epoxy groups (so as to make an epoxy resin), isocyanate groups (so as to make a polyurethane), a cyclic anhydride (so as to make a polyimide), an acid or acid halide (so as to make a polyamide) etc.

It will be understood that the above example may be extended to other platelet-like particles (as described elsewhere herein) and to reactive media other than diamines. Thus more broadly a medium having at least two reactive functional groups per molecule can be used to make a dispersion of platelet-like particles, and that may be reacted with a reagent having at least two complementary reactive functional groups per molecule to form a composite material. In this case, the complementary reactive functional groups are groups that are capable of reacting (e.g. condensing) with the reactive functional groups.

Aspects of the invention relate to the extraction of aqueous phase exfoliated 2D particles stabilised with non-ionic polymeric surfactants into an extractant. In the context of the present invention, it will be understood that a “2D” particle has a finite thickness, although that thickness may be very small and in particular is very small in relation to its other dimensions (length, width). Such particles may have a thickness of only 1 atom, or only about 2, 3, 4, 5, 6, 7, 8, 9 or 10 atoms. The mechanisms of the extraction are thought to depend on the nature of the extractant. The extractant may be non-aqueous. It may be organic. It may be non-aqueous and organic. It may for example be a halogenated extractant, an aprotic polar extractant, a glycol ether extractant, an arylalcohol extractant or an aminofunctional extractant.

The invention may be applied to a wide range of exfoliated 2D particles, for example graphene, a single layer transition metal chalcogenide, bismuth telluride etc.

Currently graphene dispersed in non-aqueous is most often used in the production of coatings and composites (plastics). Increasing the concentration of the dispersion as well as having the ability to produce dispersions in a wide variety of solvents significantly increases the potential applications and markets for these dispersions. Specifically, graphene in aprotic polar solvents is highly suited to aramid polymer (Kevlar etc.) nano-composite reinforcement. Graphene in halogenated solvents is useful for SBR (styrene-butadiene rubber) applications. Graphene in glycol ethers is suitable for use in non-aqueous paints. Reactive amines are most often used in epoxy based coatings and composites where gaphene will find use in reinforcement, improvement of thermal properties (heat conduction and de-icing), flame retardancy and water-proofing. Markets for composite materials that may be made using the dispersions of the present invention include the aerospace, sporting goods, construction, printing and packaging industries. Importantly, all of these markets are high volume applications which are now possible with improved concentrations of particles. Other markets such as electronics, semi-conductor, lubricants, catalysis (oil and gas), metal coatings (anti-corrosion, wear) may also be targeted through tailoring specific dispersants and solvent extraction techniques.

Market segments for this technology include composites manufacture and end users, coatings, paints, protective films and chemical and plastics.

Higher concentrations of the dispersions allow greater amounts of graphene or other platelet-like particles to be incorporated into products, resulting in significantly lower production costs. Flexibility of solvent systems provides improved compatibility with existing production processes leading, for example, to quicker uptake of graphene technology in to markets described above.

Most commercially available “graphene” on the market is based on graphene oxide or reduced graphene oxide. The material used in the present invention may be “pristine”, i.e. defect free as it may be generated by exfoliation of graphite itself. The present invention provides the ability to produce stable dispersions of graphene in a wide range of solvents in a wide range of concentrations.

A particular application for the dispersions of the present invention is in heat transfer fluids. Thermal properties of many liquids may be enhanced through the addition of surfactant stabilised graphene and this may make them suitable for use as heat transfer fluids. Suitable liquids or fluids include water, ethylene glycol, propylene glycol, borate esters, polyethylene oxide (or glycol) and mixtures thereof In order to be useful in this application, the dispersions should be stable at elevated temperature. Other liquids such as NMP and similar aprotic polar solvents may also act as high boiling point thermal transfer fluids on addition of graphene. Solvents with low vapour pressure are of particular interest.

Highly stable dispersions of graphene have been prepared in many solvent systems by the process described earlier in this specification. Building on the invention disclosed in International Patent Application WO2013/010211, which described the scalable production of graphene in aqueous surfactant solutions using liquid phase exfoliation, the inventor has subsequently extracted these solid materials into solvents and solvent mixtures not previously described. These particulate suspensions are stabilised against re-aggregation and sedimentation using a suitable surfactant.

There are many potential uses for these suspensions however some show particular promise in heat transfer applications due to a combination of thermal properties such as boiling point, heat capacity and thermal conductivity. Associated properties such as viscosity and critical heat flux are also important parameters that need to be considered.

Many liquids have intrinsically low thermal conductivity meaning that they are of limited use in heat transfer applications. Blending with water has been a successful strategy to overcome this limitation but with a trade-off of lower boiling point. Hence there is a need to improve thermal conductivity without sacrificing boiling point. Furthermore, there are applications such as in brake fluids where water must be strictly avoided. The present work describes the use of graphene suspended in certain solvents in thermal transfer applications.

The method for producing the graphene enhanced thermal transfer fluid is dependent on the composition of the liquid phase. For example, graphene produced using the surfactant assisted aqueous based method previously described can be subsequently blended with a non-aqueous liquid. In such an example, a 0.5% w/w suspension of graphene in water, stabilised using a non-ionic surfactant such as ethylene oxide-propylene oxide block copolymers Pluronic® F127 (approx. E0₁₀₀PO₆₅EO₁₀₀) or F108 (approx. EO₁₃₀PO₅₅EO₁₃₀) (cloud point>100° C.) is added to a similar volume of ethylene glycol through simple stirring. Depending on the desired boiling point or other thermal properties, water may be added or removed through evaporation, distillation, pervaporation, ultrafiltration, dialysis or other suitable means. Indeed all water may in some instances be removed in a similar manner to that described for the extraction of graphene from the aqueous phase into solvents such as NMP. This is described in greater detail earlier in this specification. Aside from ethylene glycol and the other solvents listed above, graphene has been added to commercially available coolants and brake fluids using the same procedure to verify that the stability of the graphene particles against re-aggregation and settling is suitable in more complex formulations than simple solvents.

The concentration of graphene may be increased further through extracting into a smaller volume of non-aqueous solvent thereby enhancing the thermal properties. There is little to no change of the boiling point of the fluids on addition of surfactant stabilised graphene. The viscosity though does increase and is dependent on the concentration of graphene particles.

In one form, the process described earlier for producing a dispersion of platelet-like particles may be conducted without step b), i.e. without removal of water. In this instance, the platelet-like particles may be graphene. The non-aqueous medium may be substituted by a water-miscible organic liquid. This may be non-aqueous or may have some water mixed with it. This process may be useful for making improved heat transfer fluids, since the presence of dispersed graphene improves the thermal conductivity of the liquid.

Suitable organic liquids include dipolar aprotic liquids such as ethylene glycol, propylene glycol, liquid borate esters, polyethylene oxide, N-methyl pyrrolidinone, dimethyl sulfoxide, hexamethylphosphoramine, hexamethylphosphoramide, ionic liquids and mixtures of any two or more of these. Preferably the liquid will have a thermal conductivity of at least about 0.1 W/m.K at 25° C. even in the absence of dispersed graphene particles. Suitable thermal conductivities are at least about 0.2, 0.3, 0.4, 0.5, 0.6, 0.7, 0.8, 0.9 or 1 W/m.K. The presence of dispersed graphene may result in a thermal conductivity of at least about 0.3 W/m.K, or at least about 0.4, 0.5, 1, 2, 3, 4, 5, 6, 7, 8, 9 or 10 W/m.K, or about 0.3 to about 15 W/m.K, or about 0.3 to 10, 0.3 to 8, 0.3 to 5, 0.3 to 2, 0.3 to 1, 0.3 to 0.5, 0.5 to 15, 1 to 15, 2 to 15, 5 to 15, 10 to 15, 1 to 10, 1 to 5, 50 to 10 m, 3 to 4 or 0.4 to 9.6 W/m.K, e.g. about 0.3, 0.4, 0.5, 0.6, 0.7, 0.8, 0.9, 1, 1.5, 2, 2.5, 3, 3.5, 4, 4.5, 5, 6, 7, 8, 9, 9.6, 10, 11, 12, 13, 14 or 15 W/m.K. The actual conductivity will depend on the water content, the nature of the solvent and the graphene content.

The ratio of water to organic liquid may be between about 1:5 and 5:1 on a weight or volume basis, optionally 1:3 and 3:1 or 1:2 and 2:1. It may be for example about 1:5, 1:4, 1:3, 1:2, 1:1 2:1, 3:1, 4:1 or 5:1.

In some instances at least a portion of the water is removed, as described elsewhere herein. Alternatively the water may remain in the dispersion. The presence of water may improve the thermal conductivity, although in some applications its relatively low boiling point is a disadvantage. The boiling point of the organic liquid may be at least about 100° C., or at least about 120, 140, 160, 180 or 200° C. High boiling points are required in high temperature applications. The boiling point of the liquid may therefore be at least about 10° C. higher than its maximum intended use temperature.

The heat transfer fluid which is obtainable by the above process may comprise a dispersion of graphene in a water miscible organic liquid. It may optionally also comprise water. In some embodiments the heat transfer fluid comprises less than about 1% by volume or weight water, or less than about 0.5, 0.2 or 0.1% water. In other embodiments the heat transfer fluid comprises between about 10 and about 80% by volume or weight water, or about 10 to 70, 10 to 60, 10 to 50, 10 to 40, 10 to 30, 20 to 80, 50 to 80 or 30 to 60% water, e.g. about 10, 20, 30, 40, 50, 60, 70 or 80% water.

### EXAMPLES

Extraction into chloroform (solvent immiscible with water)

An aqueous graphene suspension was prepared using the method previously described in WO2013/010211. In this case, a non-ionic block copolymer surfactant, Pluronic F108® was used to stabilize the exfoliated graphene sheets. The concentration of graphene in the aqueous phase was 1 mg/mL. FeCl₃ was added to the aqueous suspension of graphene to give a final concentration of 0.1M. 20 mL of the aqueous graphene suspension was then immediately transferred to a separatory funnel with 20 mL of chloroform added. The contents of the funnel were gently agitated for approximately 15 minutes, during which time the F108 stabilised graphene was extracted into the denser chloroform phase. In this way, more than 95% of the graphene was extracted from the aqueous to the organic phase as determined from UV-Visible spectrophotometry. Some material was precipitated at the liquid-liquid interface. The graphene was stable in the chloroform phase for more than 1 week before any significant sedimentation was noticeable.

The extraction procedure worked best when using water immiscible organic solvents where the liquid-liquid interfacial tension is low. Similar results for the extraction were achieved when using dichloromethane.

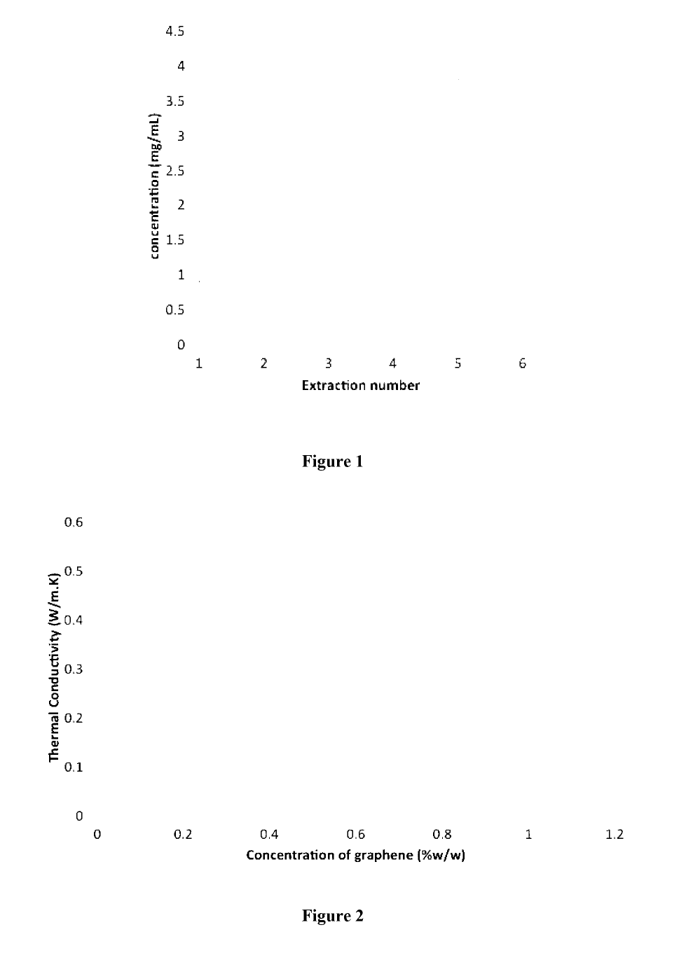

The concentration of graphene in chloroform was enriched using two methods. Firstly, after the initial extraction, the aqueous phase was removed and replaced with another fresh 20 mL aliquot of the aqueous graphene suspension with 0.1M FeCl₃. The two liquids were again gently agitated where upon the F108 stabilised graphene was extracted into the chloroform phase. This procedure could be repeated 6 times before the extraction efficiency declined substantially. The maximum achieved concentration of graphene in chloroform using this procedure was 4.2 mg/mL. A graph of graphene concentration vs extraction number is shown in FIG. 1.

A second method for creating more highly concentrated non-aqueous suspensions was also investigated. Here a single extraction step was performed using 50 mL of the 1 mg/mL aqueous graphene suspension with added FeCl₃ and 10 mL of chloroform. After gentle agitation for 15 minutes, the graphene was largely extracted into the organic phase. The concentration of graphene in chloroform was determined to be 3.9 mg/mL.

The extraction method outlined above has also been used to produce non-aqueous suspensions of other platelet-like particles aside from graphene. Aqueous suspensions of exfoliated talc, MoS₂, WS, and h-BN were prepared in a similar manner described in WO2013/010211. Again Pluronic F108 was used as the dispersant although others in the same family (L64, P123, F68, F127) have also been used. In addition to the PEO—PPO—PEO architecture, polyetheramines have been investigated. The concentration of the salt ions required to achieve successful extraction is related to the concentration of EO groups contained within the suspension. Shorter chain polymeric surfactants require less salt for a given mass concentration of graphene suspension. Very high salt concentrations (over about 0.5M) may result in aggregation and precipitation prior to extraction into the organic phase.

Extraction into N-Methypyrrolidone (Solvent Miscible with Water)

An aqueous graphene suspension using a nonionic tri-block copolymer surfactant as a dispersant was prepared using the method described in WO2013/0010211. In a typical experiment for the extraction in to a polar aprotic solvent such as NMP, DMAc, DMF or DMSO, a copolymer surfactant with a cloud point in water of greater than 100° C., e.g. Pluronics F127 or F108, was used. Other surfactants with lower cloud points may be used however the suspension may aggregate at higher temperatures for evaporation.

The aqueous suspension of graphene (1 mg/mL) stabilized with F108 was added to an equal volume of N-methylpyrrolidone in a round bottom flask. The contents of the mixture were heated under reduced pressure using a rotary evaporator. The temperature of the bath used to heat the graphene-water-NMP mixture was set to 70 ° C. to avoid rapid boiling and potential aggregation. At 70 ° C., the vapour pressures of water and NMP are 31.2 kPa and 0.8 kPa respectively. The water was evaporated until the original volume of the mixture was halved. Molecular sieves were added to the graphene suspension in NMP to collect any further traces of water. Karl-Fischer titration was subsequently performed on the suspension of graphene in NMP in order to confirm the water content (less than 0.2% w/w). The graphene suspension in NMP could also be dialysed to reduce the water content further. The concentration of graphene in NMP was determined by UV-Vis spectrophotometry to be about lmg/ml.

### Ethylene Glycol Heat Transfer Fluid Preparation and Characterisation

An aqueous suspension of graphene (1 mg/mL) stabilized with Pluronic® F108 was added to an equal volume of ethylene glycol in a round bottom flask. The contents of the mixture were heated under reduced pressure using a rotary evaporator. The temperature of the bath used to heat the graphene-water-ethylene glycol mixture was set to 70° C. to avoid rapid boiling and potential aggregation. At 70° C., the vapour pressures of water and ethylene glycol are 31.2 kPa and 0.27 kPa respectively. The water was evaporated until the final volume of the mixture was less than half of the initial volume. The boiling point of the graphene-ethylene glycol suspension was measured to be 197° C. confirming that minimal water was present.

The graphene-ethylene glycol suspension can act as an effective heat transfer agent. The thermal conductivity of the suspension was determined by measuring its thermal diffusivity using a laser flash apparatus under ASTM E1461-13 conditions. The thermal conductivity of the 1% w/w graphene in ethylene glycol suspension increased by 96% as demonstrated in FIG. 2. Similarly, a significant enhancement of the thermal conductivity was observed at graphene loading of 0.1% w/w in ethylene glycol.

### Tetraethylene Glycol Hydraulic Fluid Preparation and Characterisation

Tetraethylene glycol is a common component of many drilling, hydraulic and brake fluids. An aqueous suspension of graphene (1 mg/mL) stabilized with Pluronic® F108 was added to an equal volume of tetraethylene glycol in a round bottom flask. The contents of the mixture were heated under reduced pressure using a rotary evaporator. The temperature of the bath used to heat the graphene-water-tetraethylene glycol mixture was set to 70° C. to avoid rapid boiling and potential aggregation. At 70° C., the vapour pressures of water and tetraethylene glycol are 31.2 kPa and <0.01 kPa respectively. The water was evaporated until the final volume of the mixture was less than half of the initial volume. The thermal conductivity of the suspension was subsequently determined by measuring its thermal diffusivity using a laser flash apparatus under ASTM E1461-13 conditions with the data as a function of graphene concentration shown in FIG. 3.

1. A method for preparing a dispersion of platelet-like particles in a non-aqueous medium, said method comprising:
a) combining a dispersion of said particles in water with the non-aqueous medium to provide a mixture comprising the non-aqueous medium, water and the particles, and
b) removing the water from the mixture.

2. The method of claim 1 wherein the platelet-like particles are selected from the group consisting of exfoliated graphite, exfoliated talc, exfoliated molybdenite, exfoliated tungstenite, exfoliated tungsten disulfide, exfoliated molybdenum disulfide, exfoliated bismuth telluride, exfoliated mica and exfoliated clay, and mixtures of any two thereof.

3. The method of claim 1 or claim 2 wherein the platelet-like particles comprise graphene.

4. The method of any one of claims 1 to 3 wherein the platelet-like particles have a complete monolayer of a surfactant on the surface thereof.

5. The method of claim 4 wherein the surfactant is a polymeric surfactant.

6. The method of claim 4 or claim 5 wherein the surfactant is non-ionic.

7. The method of any one of claims 4 to 6 wherein the dispersion of the particles in water comprises a salt capable of complexing with said the surfactant.

8. The method of claim 7 wherein said salt is a salt of a multivalent cation.

9. The method of claim 8 wherein the salt is ferric chloride.

10. The method of any one of claims 7 to 9 comprising adding said salt to the water prior to step a).

11. The method of any one of claims 1 to 10 comprising the step of exfoliating a laminar material in water so as to prepare the dispersion of platelet-like particles in water.

12. The method of claim 11 wherein the step of exfoliating comprises ultrasonicating the laminar material in an aqueous solution of a surfactant for sufficient time to form the platelet-like particles in the solution, wherein at all times during the ultrasonication the concentration of the surfactant in the solution is maintained sufficient to form a complete monolayer on the surfaces of the laminar material and the platelet-like particles in the solution.

13. The method of any one of claims 1 to 12 wherein:
the non-aqueous medium has a lower vapour pressure than water, and
step b) comprises evaporating the water from the mixture so as to leave the dispersion of platelet-like particles in the non-aqueous medium.

14. The method of claim 13 wherein the non-aqueous medium is miscible with water.

15. The method of claim 14 wherein the non-aqueous medium is selected from the group consisting of benzyl alcohol, glycol ethers, reactive amines and dipolar aprotic solvents.

16. The method of any one of claims 1 to 12 wherein:
the non-aqueous medium is immiscible with water, and
step a) comprises agitating the dispersion with the non-aqueous medium, and
step b) comprises allowing the mixture to separate and separating the water from the dispersion of the platelet-like particles in the non-aqueous medium.

17. The method of claim 16 wherein the solvent is a halogenated solvent.

18. The method of any one of claims 1 to 17 additionally comprising:
adding an azeotroping solvent to the dispersion of the platelet-like particles in the non-aqueous medium, said azeotroping solvent forming an azeotrope with water and said azeotrope having a higher vapor pressure than the non-aqueous medium, and
evaporating the azeotrope from the dispersion.

19. The method of any one of claims 1 to 18 additionally comprising:
exposing the dispersion of the platelet-like particles in the non-aqueous medium to a solid drying agent, and
separating the solid drying agent from said dispersion

20. The method of claim 19 wherein the solid drying agent is a zeolite.

21. A dispersion of platelet-like particles in a non-aqueous medium which is produced by the method of any one of claims 1 to 20.

22. Use of a dispersion according to claim 21 for the manufacture of a polymer composite.

23. A method for preparing a polymer composite, said method comprising:
preparing a dispersion of platelet-like particles in a non-aqueous medium by the method of any one of claims 1 to 20, said non-aqueous medium comprising at least two amine groups per molecule,
combining said dispersion with a reagent comprising at least two amine-reactive groups per molecule, and
allowing said non-aqueous medium to react with the reagent so as to form a polymer composite comprising the platelet-like particles dispersed in a reaction product of the non-aqueous medium and the reagent.

24. Use of a dispersion according to claim 21 in semi-conductor manufacture, as a lubricant, as a catalyst, or in the production of a coating composition, ink, thermal interface material, paint, synthetic fibre or film.

25. A process for preparing a dispersion of graphene, said method comprising combining a dispersion of said particles in water with a water miscible organic liquid to provide said dispersion comprising the organic liquid, water and the particles.

26. The process of claim 25 wherein the organic liquid is a dipolar aprotic liquid.

27. The process of claim 25 wherein the organic liquid is selected from the group consisting of ethylene glycol, propylene glycol, liquid borate esters, polyethylene oxide, N-methyl pyrrolidinone, dimethyl sulfoxide, hexamethylphosphoramine, hexamethylphosphoramide, ionic liquids and mixtures of any two or more of these.

28. The process of any one of claims 25 to 27 wherein the ratio of water to organic liquid is between about 1:5 and 5:1, optionally 1:3 and 3:1 or 1:2 and 2:1.

29. The process of any one of claims 1 to 28 additionally comprising the step of removing at least a portion of the water.

30. A heat transfer fluid comprising a dispersion of graphene in a water miscible organic liquid and optionally water.

31. The heat transfer fluid of claim 30 comprising less than about 1% by volume water, wherein the organic liquid has a thermal conductivity of at least about 0.1 W/m.K at 25° C.

32. The heat transfer fluid of claim 30 or claim 31 which is made by the process of any one of claims 25 to 29.
